(19) United States
(12) Patent Application Publication
(10) Pub. No.: US 2003/0038081 A1
(43) Pub. Date: Feb. 27, 2003

(54) High strength asymmetric cellulosic membrane

(76) Inventors: I-Fan Wang, San Diego, CA (US); Richard McDonogh, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/929,821

(22) Filed: Aug. 14, 2001

(51) Int. Cl. B01D 61/00; B01D 71/10

(52) U.S. Cl. 210/651; 210/650; 210/483; 210/500.21; 210/500.29

(57) ABSTRACT

The present invention relates to ultra-thin high strength asymmetric microfiltration and ultrafiltration cellulosic membranes. The membranes are internally hydrophilic. A method of preparing such membranes and their use in separating proteins from biological liquids are also provided.

### FIELD OF THE INVENTION

The present invention relates to ultra-thin high strength asymmetric microfiltration and ultrafiltration cellulosic membranes. The membranes are internally hydrophilic. A method of preparing such membranes and their use in separating proteins from biological liquids are also provided.

### BACKGROUND OF THE INVENTION

Hydrophilic asymmetric microfiltration and ultrafiltration membranes are useful in many applications. For example, such membranes may be used for a variety of filtration applications, such as purification and testing applications in the food and dairy industry, biotechnology applications, pharmaceutical applications, medical laboratories, ultrapure water for the electronics industry, and water for injection (WFI). These applications typically require operation of the membranes in aqueous environments. The membranes may be used in a variety of forms, such as, for example, disks, cartridges, and the like. The asymmetric membranes have a large pore side and a microporous or ultraporous surface. Through applying a solids-containing liquid sample to the large pore surface, a liquid, largely free of solids, emerges from the microporous surface.

One approach to preparing membranes suitable for use in aqueous environments involves methods wherein a hydrophobic membrane is rendered hydrophilic. Water will not generally pass through hydrophobic membranes under routine operating conditions. Therefore, in applications requiring operation of the membranes in aqueous environments, the membranes, or the polymers prior to fabrication into membranes, may be reacted with, or mixed with, respectively, moieties that cause the resulting membranes to become hydrophilic. Several different processes and reagents have been utilized to cause initially hydrophilic membranes to become hydrophilic. These include surface treatments of finished membranes, inclusion of hydrophilic components in the membrane casting solution, functionalizing, for example sulfonating, hydrophobic polymers prior to casting them as membranes, cross-linking or grafting hydrophilic moieties throughout the membrane, and various other hydrophilic coating methods.

Cellulose is generally a preferred starting material for preparation of such membranes because of its hydrophilicity. Prior art conventional methods for preparing cellulose membranes include melt extrusion methods utilizing polyethylene glycol or other plasticizers such as sulfolane. For example, U.S. Pat. No. 5,897,817 and U.S. Pat. No. 5,897,817 disclose methods for making semipermeable membranes from cellulose acetate. In the process, a molten liquid comprising cellulose acetate is extruded to produce a membrane, then the solvent, e.g., polyethylene glycol, and non-solvent are removed from the membrane to produce a semipermeable membrane. U.S. Pat. No. 4,933,084 discloses dialysis membranes in the shape of hollow fibers composed of cellulose regenerated from copper-ammonia solution. U.S. Pat. No. 4,543,221 discloses cellulose semipermeable hollow fibers useful in detoxifying blood during hemodialysis or hemofiltration treatments. The cellulose fibers are made by melt extrusion of certain cellulose ester polyol melt spin compositions into self-supporting gelled fibers. The cellulose ester gelled fibers are subsequently chemically converted into cellulose fibers by deacetylation in aqueous alkali solution. U.S. Pat. No. 4,276,173 discloses a cellulose acetate semi-permeable hollow fiber suitable for use in artificial kidneys and a process for making same from a mixture of cellulose acetate, glycerin, and polyethylene glycol. U.S. Pat. Nos. 3,532,527 and 3,494,780 describe a process of melt spinning cellulose esters, particularly cellulose triacetate and cellulose acetate, from a melt-spin composition consisting of a compatible plasticizer of the tetramethylene sulfone type.

### SUMMARY OF THE INVENTION

The present invention provides membranes and methods for preparing membranes consisting of asymmetric microfiltration and ultrafiltration cellulosic membranes. The membranes are internally hydrophilic, and may be used in food and dairy or biotechnology applications.

In a first embodiment, a cellulosic membrane is provided, the membrane cast from a dope including a cellulosic polymer and a solvent, the membrane having a first porous face having a first average pore diameter, a second porous face having a second average pore diameter, and a porous supporting structure therebetween wherein the supporting structure includes a reticulated network of flow channels, the first and second average pore diameters having an asymmetry of at least about 2:1, and wherein the porous faces and the porous supporting structure include a network of structural surfaces capable of contacting a filter stream.

In various aspects of this embodiment, the asymmetry between the average pore diameters of the first porous face and the second porous face is at least about 5:1, at least about 10:1, or at least about 20:1.

In other aspects of this embodiment, the membrane has a molecular weight cut-off ranging from about 10 k Daltons to about 300 k Daltons, about 10 k Daltons to about 50 k Daltons, or about 10 k Daltons to about 30 k Daltons.

In another aspect of this embodiment, the cellulosic polymer may include a cellulose ester. The cellulose ester may include a cellulose acetate, for example, a cellulose acetate such as cellulose diacetate, cellulose triacetate, cellulose acetate butyrate, cellulose acetate propionate, cellulose nitrate, methyl cellulose, and mixtures thereof.

In a further aspect of this embodiment, the cellulosic polymer on a surface of the membrane includes cellulose. The cellulose may be produced via hydrolyzation of the membrane or via saponification of the membrane.

In other aspects of this embodiment, the dope includes a dispersion of the cellulosic polymer in the solvent, or a homogeneous solution of the cellulosic polymer in the solvent.

In a second embodiment, a method for preparing a cellulosic membrane is provided, the method including: providing a casting dope including a cellulosic polymer, a nonsolvent, and a solvent; casting the dope to form a thin film; exposing the film to a humid atmosphere for a period of time sufficient to allow formation of surface pores; coagulating the film in a coagulation bath; and recovering from the coagulation bath a cellulosic membrane, the membrane having a first porous face having a first average pore diameter, a second porous face having a second average pore diameter, and a porous supporting structure therebetween, the first and second average pore diameters having an asymmetry of at least about 2:1, wherein the porous faces and the porous supporting structure include a network of structural surfaces capable of contacting a filter stream, and wherein the structural surfaces include a hydrophilic moiety.

In an aspect of this embodiment, the method may further include rinsing the membrane in a rinsing bath, wherein the rinsing step is conducted after the coagulating step.

In further aspects of this embodiment, the method may include drying the membrane at an elevated temperature or at room temperature.

In other aspects of this embodiment, the dope may include a homogeneous solution or a dispersion.

In further aspects of this embodiment, the nonsolvent may include alcohols, alkanes, ketones, carboxylic acids, ethers, esters, and mixtures thereof. The nonsolvent may include 2-methoxyethanol, propionic acid, t-amyl alcohol, methanol, ethanol, isopropanol, hexanol, heptanol, octanol, acetone, butyl ether, methylethylketone, methylisobutylketone, ethyl acetate, amyl acetate, glycerol, diethyleneglycol, di(ethyleneglycol)diethylether, di(ethyleneglycol)dibutylether, polyethylene glycol, propionic acid, hexane, propane, nitropropane, heptane, octane, or mixtures thereof. The nonsolvent may include water, an alcohol, or mixtures thereof. The alcohol may include methanol, ethanol, or mixtures thereof.

In other aspects of this embodiment, the solvent may include dimethylformamide, dimethylacetamide, dioxane, dimethylsulfoxide, chloroform, tetramethylurea, tetrachloroethane, and mixtures thereof. The solvent may include N-methylpyrrolidone or methylene chloride.

In further aspects of this embodiment, the dope further includes triethylene glycol or a hydrophilic component.

In various aspects of this embodiment, the dope includes from about 2 wt. % to about 60 wt. % of nonsolvent, from about 40 wt. % to about 75 wt. % of solvent, from about 3 wt. % to about 20 wt. % of cellulosic polymer, or up to about 5 wt. % of triethylene glycol.

In a further aspect of this embodiment, the coagulation bath includes water. The coagulation bath may further include methanol.

In another aspect of this embodiment, the rinse bath includes water.

In a third embodiment, a method for separating a protein from a liquid is provided, the method including: providing a liquid containing a protein; providing a cellulosic membrane, the membrane cast from a dope including a cellulosic polymer and a solvent, wherein the membrane has a first porous face having a first average pore diameter, a second porous face having a second average pore diameter, and a porous supporting structure therebetween wherein the supporting structure includes a reticulated network of flow channels, the first and second average pore diameters having an asymmetry of at least about 2:1, wherein the porous faces and the porous supporting structure include a network of structural surfaces capable of contacting a filter stream, wherein the membrane includes a cellulosic polymer, wherein the structural surfaces include a hydrophilic moiety, and wherein the membrane has a molecular weight cut-off ranging from about 10 k Daltons to about 300 k Daltons; and contacting the liquid with the membrane, whereby a filtrate passes through the membrane and whereby a substantial quantity of the protein is retained by the membrane.

In one aspect of this embodiment, the liquid includes a dairy product, such as milk, or bioprocessing stream.

### BRIEF DESCRIPTION OF THE DRAWINGS

FIGS. 1a-c provide scanning electron microscope (SEM) images of the 0.6 μm asymmetric microfiltration membrane of Example 1. FIG. 1a is an image of a cross section of the membrane. FIG. 1b is an image of the skin surface of the membrane. FIG. 1c is an image of the dull surface of the membrane.

FIGS. 2a-c provide SEM images of the 0.1 μm asymmetric microfiltration membrane of Example 2. FIG. 2a is an image of a cross section of the membrane. FIG. 2b is an image of the skin surface of the membrane. FIG. 2c is an image of the dull surface of the membrane.

FIGS. 3a-c provide SEM images of the 0.1 μm symmetric microfiltration membrane of Example 3. FIG. 3a is an image of a cross section of the membrane. FIG. 3b is an image of the skin surface of the membrane. FIG. 3c is an image of the dull surface of the membrane.

FIG. 4a provides a SEM image of a cross section of the asymmetric ultrafiltration membrane of Example 4 before regeneration.

FIG. 4b provides a SEM image of a cross section of the asymmetric ultrafiltration membrane of Example 4 after regeneration.

### DETAILED DESCRIPTION OF THE PREFERRED EMBODIMENT

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

Conventional methods for preparing cellulose acetate fibers typically suffer from the disadvantages of low flow rates and poor mechanical properties. A method for preparing cellulose acetate membranes that yields membranes having satisfactory flow rates and good mechanical properties is therefore desirable.

### Introduction

Supported ultra-thin high strength asymmetric microfiltration and ultrafiltration cellulosic membranes may be prepared without the use of a thermally-induced phase separation process in a melt cellulosic material by melt extrusion, such as in a melt cellulose acetate at a temperature of from about 165° C. to about 180° C. Such membranes are internally hydrophilic, have strong mechanical properties, for example, high tensile strength, have high protein flow rates and good structural integrity. The membranes demonstrate good wet strength during hydrolysis and conversion from cellulose ester to regenerated cellulose. Although membranes of certain preferred embodiments may be thinner than commercially available cellulosic membranes, they generally demonstrate improved mechanical properties than conventional cellulosic membranes. The preferred membranes are typically between about 10 μm and about 120 μm thick, and are particularly well suited for use in the dairy and biotechnology industries.

### Cellulose Esters

The membranes of preferred embodiments may be prepared from one or more cellulosic materials, such as a cellulosic polymer, cellulose ester, or derivative thereof, capable of forming a membrane. The cellulose esters that are suitable include the cellulose mono-, di- and triacetates and mixtures thereof, cellulose acetate propionate, cellulose acetate butyrate, cellulose propionate, and cellulose butyrate, mixtures of any two or more thereof, or any other suitable ester of cellulose. Cellulose nitrate and ethyl cellulose may also be used. The cellulose acetates are preferred, particularly cellulose diacetate. Cellulose diacetate mixtures typically include at least a minor proportion of one or more other cellulose acetates. Suitable cellulose acetate may be obtained from Eastman Chemical Company of Kingsport, Tenn.

In various embodiments, the cellulose ester may be used alone or in combination with other suitable materials. The material may be subjected to a pretreatment such as, for example, grafting or functionalization, prior to forming the casting dope. There is no particular molecular weight range limitation for useful materials.

### The Membrane

Membranes that may be prepared in accordance with preferred embodiments include ultrafiltration and microfiltration asymmetric cellulosic membranes. The term “asymmetric” as used herein relates to a membrane possessing a pore size gradient. That is, asymmetric membranes possess their smallest or finest pores in or adjacent to one surface of the membrane, generally referred to as the “skin” surface or “shiny” side of the membrane. The increase in pore size between the skin surface and the opposite surface of the membrane is generally gradual, with the smallest pore size nearest the skin surface and the largest pores being found at or adjacent to the opposite, coarse-pored surface, generally referred to as the “open” surface or the “dull” side of the membrane. Another variety of asymmetric membrane, commonly described as having a “funnel-with-a-neck” structure, includes both an asymmetric region and an isotropic region, the isotropic region having a uniform pore size. The isotropic region typically extends from the skin surface of the membrane through about 5-80% of the thickness of the membrane, more preferably from about 15-50% of the thickness of the membrane. Symmetric membranes exhibit a substantially uniform pore size throughout the thickness of the membrane. Although asymmetric membranes are generally preferred for filtering applications, in certain embodiments a symmetric membrane may be preferred.

Some filtration membranes have a layer of relatively small pores on one side (termed herein a “skin”) when compared to the other side, while other membranes do not contain this type of layer (termed herein “skinless”). A skinned membrane is typically created by quenching a polymeric casting solution of sufficient polymer concentration in a strong non-solvent. The resultant membrane has considerably smaller pores on the “skin” face than on the opposite face.

The membranes of preferred embodiments have a porous supporting structure between the two sides of the membrane. The nature of the porous supporting structure of a membrane may depend on the composition of the casting dope and the coagulation bath. The supporting structure may include closed cells, open cells of substantially the same pore size from one side of the membrane to the other, open cells with a gradation of pore sizes from one side of the membrane to the other, or finger-type structures, generally referred to as “macrovoids.” Macrovoids typically will vary substantially in size from the surrounding porosity, and generally do not communicate with surface pores. In a preferred embodiment, the porous supporting structure includes a network of structural surfaces capable of contacting a filter stream, defined herein as including any fluid substance, including liquids and gases, that passes through the membrane via the porous supporting structure. In preferred embodiments, the supporting structure includes reticulated network of flow channels. In particularly preferred embodiments, the supporting structure includes either no macrovoids or an insignificant number of macrovoids.

Whether the membrane has an asymmetric or funnel-with-a-neck structure may depend upon several factors involved in the preparation of the membrane, including the type and concentration of the polymer, the solvent, and the nonsolvent; the casting conditions such as the knife gap, and the dope temperature; environmental factors such as the exposure time between casting and quenching, and the humidity of the exposure atmosphere; and the composition and temperature of the quench bath.

In particularly preferred embodiments, the membranes have an asymmetric structure wherein an increase in pore size is observed from one side of the membrane to the other. In various embodiments, the asymmetry in pore size between the skin side and dull side of the membrane may range from about 1:1.5, 1:2, 1:5, 1:10, or 1:20 or greater.

Suitable membranes may typically possess porosities characteristic of ultrafiltration or microfiltration membranes. Membranes within the ultrafiltration range preferably possess molecular weight cutoffs of from about 10,000 Daltons to about 1,000,000 Daltons and may have pore diameters from about 0.001 μm to about 0.050 μm on the skin side of the membrane. Microfiltration membranes typically possess pore diameters of at least about 0.01 or about 0.05 μm to about 5, 8, 10 or 20 μm on the skin side of the membrane.

The cellulosic membranes that may be prepared according to the preferred embodiments may be in any suitable shape or form, including, but not limited to, sheet and hollow fiber cast polymer membranes. Suitable membranes further include both those membranes that are cast from a single polymer solution or dope, referred to as “integral” membranes, as well as non-integral or composite membranes that are cast from more than one polymer solution or dope to form a layered or composite membrane. Composite membranes may also be assembled from two or more fully formed membranes after casting. In preferred embodiments, the membrane is cast from a polymer solution or dope directly onto a support, after which the polymer solution or dope is coagulated to form the resulting membrane.

### The Casting Dope

The cellulosic membranes of the preferred embodiments are preferably prepared from stable, clear homogeneous solutions and/or stable colloidal dispersions. The solutions or dispersions can be prepared through the use of solvents alone, or in combination with non-solvents.

The membranes are generally prepared from a casting solution or dispersion of a cellulosic polymer, along with particular concentrations of polymer solvents and non-solvents. The concentration of the polymer in the casting solution is low enough to form a substantially all-reticulated structure, but high enough to produce a coherent membrane. If the polymer concentration is too low, the resulting membrane can have inadequate coherency and, in the extreme case, only dust is formed. If the polymer concentration is too high, the membrane structure is not substantially reticulated and can contain at least some granular structures.

Although the appropriate concentration of the cellulosic polymer varies somewhat depending upon the particular conditions used, (e.g., solvents, etc.), the cellulosic polymer concentration is generally from about 3 wt. % to about 20 wt. %. Typically, the casting solution contains from about 5 wt. % to about 15 wt. % cellulosic polymer, preferably the casting solution includes about 8 wt. % to about 12 wt. % cellulosic polymer, and most preferably the polymer is cellulose acetate at about 9 wt. %, about 10 wt. %, or about 11 wt. %.

More surface porosity may be obtained in the membranes of the preferred embodiments through co-casting the cellulosic polymer with one or more optional hydrophilic components, such as hydrophilic polymers or oligomers, or surfactants. In a preferred embodiment, the optional hydrophilic component is triethylene glycol. Other suitable optional hydrophilic polymers include polyethylene glycol, polyvinylpyrrolidone, and polyvinylacetate. A suitable concentration of the optional hydrophilic polymer or surfactant can vary depending upon the particular composition of the dope mix and the casting and quenching conditions used. However, when the optional hydrophilic component is present in the casting dope, the concentration is generally from about 0.1 wt. % to about 10 wt. % of the solution, preferably from about 0.2 wt. % to about 6 wt. % of the solution, more preferably from about 0.3 wt. % to about 5 wt. % of the solution, still more preferably from about 0.3 to 2 wt. % of the solution, and most preferably the optional hydrophilic component is triethylene glycol and is present at about 0.3 wt. % of the solution.

In a preferred embodiment, the membrane is subjected to a post-treatment step including hydrolyzation or saponification in an alkali bath, as discussed below, in order to regenerate the cellulose acetate in the membrane to cellulose. The resulting cellulose membrane generally exhibits improved solvent resistance when compared to the corresponding cellulose acetate membrane. Other post-treatments, such as grafting or crosslinking a hydrophilic component, may also be conducted.

It has been found that a stable, clear homogeneous casting solution or stable colloidal dispersion can be obtained by dissolving the polymer in a suitable solvent such as, for example, methylene chloride or N-methyl pyrrolidone. Any suitable solvent may be used, however. Examples of other suitable solvents include dipolar aprotic solvents such as dimethylformamide, dimethylacetamide, dioxane, dimethylsulfoxide, chloroform, tetramethylurea, or tetrachloroethane, and their mixtures.

The amount of solvent that may be employed to prepare preferred membranes can be between about 30 wt. % and about 80 wt. %; desirably between about 35 wt. % and about 75 wt. %; more desirably between about 40 wt. % and about 75 wt. %, preferably between about 40 wt. % and about 71 wt. %; and most preferably the solvent is N-methylpyrrolidone and is present at about 41 or 46 wt. % of the solution, or methylene chloride and is present at about 70 or 71 wt. % of the solution. The precise amount of solvent to be used is determined by the particular casting solution, including the particular polymer, non-solvent, and the other conditions of the method of preparation of the particular membrane of interest.

A non-solvent may be added to the casting solution. In a preferred embodiment, the non-solvent includes water and/or methanol or ethanol. The components of the casting solution may be added in any suitable order. However, it is convenient to add the non-solvent to the casting solution at the same time as the cellulosic polymer is dissolved in the solvent. Additional examples of appropriate non-solvents include alcohols, for example, isopropanol, 2-methoxyethanol, amyl alcohols such as t-amyl alcohol, hexanols, heptanols, and octanols; alkanes such as hexane, propane, nitropropane, heptane, and octane; and ketones, carboxylic acids, ethers and esters such as acetone, propionic acid, butyl ether, ethyl acetate, and amyl acetate, di(ethyleneglycol) diethylether, di(ethyleneglycol) dibutylether, polyethylene glycol, methylethyl-ketone, methylisobutylketone, glycerol, diethyleneglycol, and their mixtures.

The total amount of non-solvent which may be employed to prepare the membrane varies for different non-solvents. For example, the preferred amount of non-solvent may be different for water than it is for an alcohol. The preferred amount of non-solvent is typically between about 5 wt. % or about 10 wt. % and about 55 wt. % of the casting solution; preferably between about 20 wt. % and about 50 wt. %; more preferably between about 23 wt. % and 49 wt. %; and most preferably about 23, 23.5, 44.6, or 49 wt. % of the casting solution. In a preferred embodiment, methanol makes up about 20.9 or 21.4 wt. % and water about 2.1 wt. % of the casting solution. However, selection of the precise amount of non-solvent to be used is based on the particular casting solution, including particular polymer, solvent and the other conditions of the method of preparation of the particular membrane of interest.

### The Casting Process

In general, the overall method of preparing preferred cellulosic membranes includes the steps of providing a casting dope comprising a solution or stable colloidal dispersion. In preferred embodiments, the casting dope is cast as a thin film and exposed to a gaseous environment. Once the casting dope has been exposed to the gaseous environment, it is coagulated in a quench bath. After coagulating, the resulting cellulosic membrane may be rinsed in a suitable solvent, then air- or oven-dried. The cellulosic membrane may then be subject to hydrolyzation or saponification.

The cellulosic membranes of preferred embodiments can be cast using any conventional procedure wherein the casting solution or dispersion is spread in a layer onto a porous or nonporous support from which the membrane later can be separated after quenching, or upon which the membrane may be retained. The membranes can be cast manually by being poured, cast, or spread by hand onto a casting surface followed by application of a quench liquid onto the casting surface. Alternatively, the membranes may be cast automatically by pouring or otherwise casting the solution onto a moving belt. The casting solution or dispersion may be any suitable temperature, i.e., room temperature, or any temperature at which the casting dope is capable of being cast. Preferably, the temperature is between about 10° C. and about 38° C., more preferably between about 16° C. and about 32° C., and most preferably between about 21° C. and about 26° C. In preferred embodiments, the temperature is preferably about room temperature.

One type of moving belt support is polyethylene-coated paper. In casting, particularly in automatic casting, mechanical spreaders can be used. Mechanical spreaders include spreading knives, a doctor blade or spray/pressurized systems. A preferred spreading device is an extrusion die or slot coater which has a chamber into which the casting formulation can be introduced. The casting solution is then forced out of the chamber under pressure through a narrow slot. Membranes may also be cast by means of a doctor blade with a knife gap from preferably less than about 150 μm (6 mils), about 150 μm (6 mils), or about 175 μm (7 mils) to about 250 μm (10 mils), about 300 μm (12 mils) or more; more preferably from about 150 μm (6 mils) to about 300 μm (12 mils); and most preferably from about 175 μm (7 mils) to about 250 μm (10 mils). The relationship between the knife gap at casting and the final thickness of the membrane is a function of the composition and temperature of the casting solution, the duration of exposure to the gaseous environment, such as humid air, the relative humidity of the air during exposure. In addition, the temperature of the quench bath and many other factors can affect the overall thickness of the final membrane. Membranes typically shrink upon gelling, losing from about 20% to about 80% of their thickness.

In preferred embodiments, the cast film is exposed to a gaseous environment, such as air, sufficiently long to induce formation of surface pores. Another factor that is important to the manufacture of the membranes of the preferred embodiments is the exposure time and exposure conditions that exist between casting and quenching the casting solution. Preferably, the casting solution or dispersion is exposed to humid air after casting but before quenching. Ambient humidity is acceptable as are other humidity conditions. In a preferred embodiment, the gaseous environment has a relative humidity of between about 50% and about 75%, preferably between about 55% and about 70%, more preferably between about 60% and about 65%, and most preferably about 60%. In addition, the air is preferably circulated to enhance contact with the cast solution or dispersion. The gaseous atmosphere may be any suitable temperature, but is typically between about 10° C. and about 30° C., preferably between about 15° C. and about 25° C., and more preferably between about 20° C. and about 25° C. Most preferably, the temperature is from about room temperature to slightly higher than room temperature.

The method of preparing the membranes of the preferred embodiments typically involves a period of exposure to the gaseous environment after casting and before quenching. The exposure time to the gaseous environment is preferably between about 0 seconds and about 10 seconds or more. More preferably, the exposure time is between about 1 second and about 5 seconds, and most preferably between about 1 second and about 2 seconds. Increasing the air exposure time over this range tends to increase permeability and pore size of the resulting membrane.

Following casting and exposure to a gaseous environment, such as air, the cast dispersion or solution is quenched or coagulated. In a preferred embodiment, quenching is accomplished by transporting the cast membrane on a moving belt into the quenching liquid, such as a water bath or a mixture of methanol and water. Most commonly, the quenching or coagulating liquid is water, however, any suitable liquid or mixture of liquids that is not a solvent for the resulting cellulosic membrane may be used. In the quench or coagulating bath, the polymer precipitates or coagulates to produce the desired porous reticulated structure.

The temperature of the quench bath can affect the porosity of the membrane. In general, warmer quench baths result in more porous membranes. Generally, a wide temperature range may be utilized in the quenching step, ranging from about −2° C. to about 40° C., preferably from about 5° C. to about 30° C., and more preferably from about 10° C. to about 25° C. The lower temperature limit is determined by the freezing point of the particular quench liquid. Preferably, the quench liquid is water or a mixture of methanol and water and the quenching temperature is about 20° C. The temperature of the quench bath may cause marked changes in the pore diameters of the membrane. Where higher quench temperatures are utilized, the membranes possess larger pores. Conversely, where lower temperatures are utilized, smaller pores form.

Membranes are recovered from the quench bath in the conventional manner by physical removal. The resulting cellulosic membrane is typically washed free of solvent and may be dried to expel additional increments of solvent, diluent, and quench liquid. Washing liquids include any suitable liquid that is not a solvent for the resulting cellulosic membrane. In a preferred embodiment, the rinse liquid is deionized water. The membranes may be dried by air drying or oven drying. In a preferred embodiment, the cellulosic membrane is air dried at room temperature. If drying at elevated temperature, e.g., in an oven, is performed, the temperature is typically selected such that exposure of the membrane to that temperature does not substantially affect the performance characteristics of the membrane, for example, by melting the polymer comprising the membrane. Preferably, drying temperatures ranging from about 50° C. to about 100° C., more preferably from about 60° C. to about 90° C., and most preferably from about 70° C. to about 80° C. are used. It is preferred to circulate the air in oven so as to ensure rapid and even drying. The humidity of the air in the oven need not be controlled. However, drying tends to be more rapid at lower humidity levels.

The cellulosic membranes produced by the methods described above may be from about 5 μm to about 500 μm thick, or more. Preferably, the thickness of the membrane is about 10 μm to about 200 μm. More preferably, the membrane thickness is about 20 82 m to about 120 μm. However, any useful thickness of membrane can be prepared by varying the process parameters following the teachings herein.

### Hydrolyzation or Saponification

In preferred embodiments, the cellulose acetate membranes are hydrolyzed or saponified in an alkali bath to regenerate the cellulose acetate to cellulose. The bath preferably comprises and aqueous or alcoholic solution, however, any suitable solvent system may be used. One or more alkali materials, such as sodium hydroxide, are dissolved in the solvent system. Any effective concentration of alkali may be used, preferably from about 1 wt. % to about 20 wt. %, more preferably from about 5 wt. % to about 10 wt. %. The temperature of the alkali bath may range between just above the freezing point of the solution to the boiling point of the solution, provided that the temperature is such that exposure of the membrane to the bath will not substantially affect the structural integrity of the membrane. Preferably, a room temperature alkali bath is used. The membrane is generally immersed in the bath for a time period sufficient to result in substantial saponification or hydrolyzation of the membrane whereby the membrane is rendered internally hydrophilic. Typically, an immersion time of between about 1 minute and about 5 minutes is sufficient for the membranes of the preferred embodiments. However, longer or shorter immersion times may be preferred for certain embodiments.

After immersion, the membrane may be rinsed with a suitable solution and air- or oven-dried. Hydrolyzation or saponification may be performed at any time after quenching of the casting solution, such as before rinsing, before drying, or before or after formation of a composite membrane. The membranes are preferably immersed in glycerin prior to storage, or stored under glycerin so as to minimize surface pore densification or collapse. In certain embodiments, however, it may be desirable to forego immersing or storing the membrane in glycerin.

### Membrane Architecture

Cellulosic membranes of the preferred embodiments are typically made from cellulose acetate. Asymmetry in pore size may range from about 1:1.5 and up. Asymmetry preferably ranges from about 1:1.5 to about 1:20, more preferably from about 1:1.5 to about 1:10, and most preferably from about 1:2 to about 1:5. Pore sizes preferably range from about 0.001 μm or less to about 20 μm or more, more preferably from about 0.005 μm to about 10 μm, and most preferably from about 0.005 μm to about 5 μm.

Pore diameter in preferred cellulosic membranes is generally estimated by porometry analysis and by separate measurement of the bubble point, with a higher bubble point indicating tighter pores. Porometry consists of applying gradually increasing pressures on a wet membrane and comparing gas flow rates with those of the dry membrane, which yields data on pore diameters as well as the bubble point. The bubble point test procedure is commonly used to determine maximum pore size. Porometry measurements give the “mean flow pore diameter” (MFP diameter, also referred to as MFP size) of the membrane. The MFP diameter is the average size of the limiting pores in a membrane. The MFP diameter is based on the pressure at which air flow begins through a pre-wetted membrane (the bubble point pressure) compared to the pressure at which the air flow rate through a pre-wetted membrane is half the air flow rate through the same membrane when dry (the mean flow pore pressure). A Coulter Porometer, manufactured by Beckman Coulter Inc. of Fullerton, Calif., is typically used for analysis of MFP diameter and minimum pore size. The membranes of the preferred embodiments preferably have MFP diameters ranging from about 0.005 or less to about 20 or more, more preferably from about 0.005 to about 10, and most preferably from about 0.005 to about 5. However, in certain embodiments higher or lower MFP diameters may be preferred.

One property of porous membranes is minimum pore size, which may be determined using particle retention test methods. Particle retention is typically determined using a latex retention test. In the test, a solution containing latex beads of a specific size, e.g., 0.091 μm, 0.198 μm, or 0.46 μm, is contacted with the membrane and a filtrate collected. The optical density of the filtrate is then compared to a blank to determine the percentage of latex in the filtrate. This value may be used to calculate the particle retention percentage for a given size latex bead. By successively testing the membrane with smaller and smaller particle sizes, the minimum pore size of the membrane, corresponding to the smallest particle size that is substantially retained by the membrane, may be determined.

### Composites Including Cellulosic Membranes

In preferred embodiments, the cellulosic membranes are fabricated into composite membranes or filters. Such composites have multiple layers and are useful in a variety of separation applications. In many cases, the various layers of a composite membrane or filter each impart different desirable properties. For example, in some applications, an extremely thin membrane may have advantageous flow rates in separations of very small particles, gasses, and the like. Yet such a thin membrane may be fragile and difficult to handle or to package into cartridges. In such cases, the fragile, thin layer membrane may be combined with a support material as a backing to form a composite having improved strength and handling characteristics without sacrificing the separations properties of the thin layer membrane. Other desirable properties imparted by forming a composite membrane may include increased burst strength, increased tensile strength, increased thickness, and superior prefiltration capability.

Composite membranes or filters incorporating the membranes of the preferred embodiments may be prepared using lamination techniques. In a typical lamination process, for example, the membrane and one or more additional sheets are layered together to form a stack, which is then laminated into an integral composite under application of heat and pressure. An adhesive substance may be placed in between the membrane and the adjacent sheet prior to lamination to facilitate binding and lamination of the membrane and sheet to each other.

Another approach to preparing composite membranes is to cast or form one membrane layer in situ on top of another layer such as, for example, a woven or nonwoven support. Alternatively, the membrane may be cast or formed on top of another layer, such as, for example, a membrane or other backing material. In a preferred embodiment, the membranes of the preferred embodiments are cast in situ on top of a polyester non-woven support, such as RO Support available from Veratec of Athens, Ga.

Any cellulosic membrane that may be prepared according to the preferred embodiments by a casting or other process, that possesses the pore size criteria described above, and which is internally hydrophilic is generally suitable for use in the present invention. Generally, hydrophilicity is a characteristic of materials exhibiting an affinity for water. Hydrophilic materials readily adsorb water and possess a high surface tension value. In a preferred embodiment, the developed cellulosic membrane is hydrolyzed or saponified in an aqueous or alcohol alkali bath. The hydrolysis process imparts a high degree of hydrophilicity to the finished membrane.

### Antibody or Protein Recovery

The membranes of preferred embodiments are particularly suited to use in recovering and/or removing antibodies or proteins from liquids, including biological liquids such as milk. Such membranes preferably possess porosities characteristic of ultrafiltration membranes, i.e., molecular weight cutoffs of from about 10,000 Daltons to about 1,000,000 Daltons and pore diameters from about 0.001 μm to about 0.050 μm on the skin side of the membrane. When the membranes are to be used in dairy applications, for example, in milk processing to recover antibodies, the molecular weight cut-off is preferably from about 10,000 Daltons or less to about 300,000 Daltons or more; more preferably from about 10,000 Daltons to about 300,000 Daltons, about 200,000 Daltons, or about 100,000 Daltons; and is most preferably from about 10,000 Daltons to about 30,000 Daltons or about 50,000 Daltons. Such membranes are generally suitable for use in recovering or removing proteins, polypeptides, and antibodies. Examples of such substances include, but are not limited to, bovine serum albumin, immunoglobulin, and chymotrypsin. In a preferred embodiment, the membrane is used to separate antibodies from whey protein.

Membranes for use in antibody recovery preferably have some degree of asymmetry, more preferably an asymmetry of at least about 1:2, most preferably an asymmetry of from about 1:2 to about 1:5. Asymmetric membranes are preferred because they typically possess superior flow rates than do isotropic (symmetric) membranes. However, in certain antibody filtration methods isotropic membranes may be preferred or may be used with satisfactory results.

Because of the combination of internal structure and hydrophilicity, the membranes of preferred embodiments in many cases have flow rates that are superior to comparable membranes cast from hydrophobic polymers, for example sulfone polymers, or conventional cellulosic membranes. Flow rates in ml/min for a 90 mm disc at pressures of 10 psi (69 kPa) for the membranes of preferred embodiments may range from less than 0.5, 0.75, 1, 1.25, 1.5, 1.67, 1.68, 1.75, 2, 2.25, 2.5, 2.75, 3, 3.5, 4, 4.5, 5, 10, 20, 30, 40, 50, 100, 180, 230, 280, 300, 400, 500, 600, 700, 800, 900, 1000, 1250, 1500, 1750, 2000, 2500, 3000, 3600, 4000, to 5000 or more.

### EXAMPLES

### Example 1

### 0.6 μm Asymmetric Microfiltration Membrane

A solution containing 2.5 wt. % cellulose triacetate CA 436-80S (acetyl content of 43.6 wt. %, viscosity of 304 Poises, purchased from Eastman Chemical Co. of Kingsport, Tenn.), 1.6 wt. % cellulose acetate CA 394-60S (acetyl content of 39.5 wt. %, viscosity of 228 Poises, purchased from Eastman Chemical Co.), 1.6 wt. % CA 398-30 (acetyl content of 39.7 wt. %, viscosity of 114 Poises, purchased from Eastman Chemical Co.), 20.9 wt. % methanol (purchased from Aldrich of Milwaukee, Wis.), 2.1 wt. % de-ionized water, 71 wt. % methylene chloride (purchased from Aldrich), and 0.3 wt. % triethylene glycol (purchased from Aldrich) was prepared. The casting solution, at room temperature, was cast onto a moving belt of polyethylene coated paper using a casting knife. Following casting, the cast solution was quenched in a bath including 75 vol. % methanol and 25 vol. % water. The cast solution was exposed to air for approximately 3 to 4 seconds before quenching. The air was at room temperature and had a relative humidity of approximately 60%. The quench bath had a temperature of approximately 20° C. The resulting membrane was rinsed with deionized water and air dried. The membrane, which was internally hydrophilic, was not subjected to hydrolyzation or saponification.

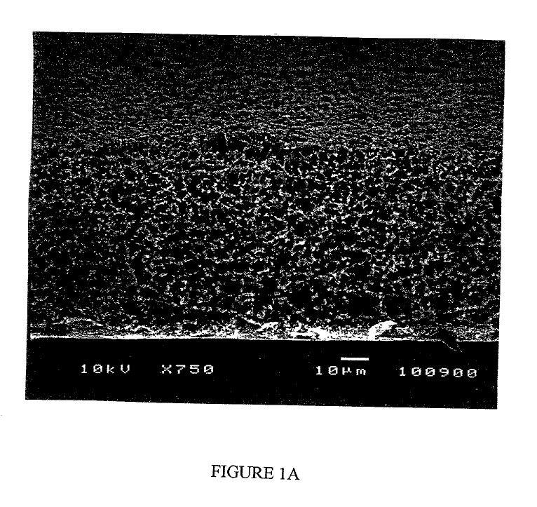

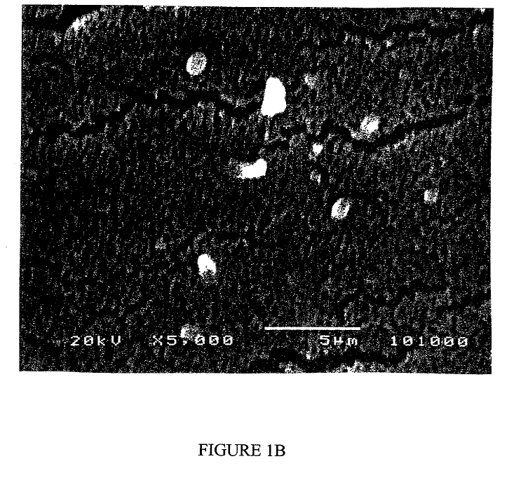

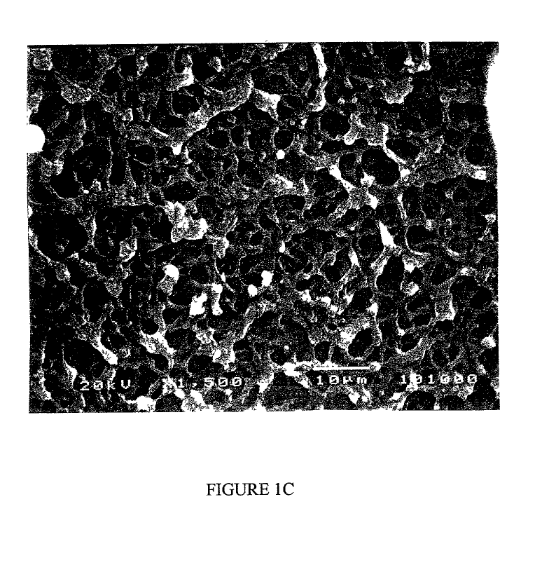

The membrane, having a thickness of approximately 70 μm, exhibited an asymmetry in pore size between the skin surface and the dull surface of approximately 1:20. FIG. 1a provides a scanning electron microscope (SEM) image of a cross section of the membrane. FIG. 1b provides a SEM image of the skin surface of the membrane. FIG. 1c provides a SEM image of the dull surface of the membrane. The membrane was subjected to water flow testing. Maximum pore size, minimum pore size, and MFP size were determined as described above. Test data are provided in Table 1 below.

### Example 2

### 0.1 μm Asymmetric Microfiltration Membrane

A solution containing 2.5 wt. % cellulose acetate CA 436-80S, 1.8 wt. % cellulose acetate CA 394-60S, 1.8 wt. % CA 398-30, 21.4 wt. % methanol, 2.1 wt. % water, 70 wt. % methylene chloride, and 0.3 wt. % triethylene glycol was prepared. The casting solution, at room temperature, was cast onto a moving belt of polyethylene coated paper using a casting knife. Following casting, the cast solution was quenched in a bath including 82 vol. % methanol and 18 vol. % water. The quench bath had a temperature of approximately 20° C. The cast solution was exposed to air for approximately 1 to 2 seconds before quenching. The air was at room temperature and had a relative humidity of approximately 60%. The resulting membrane was rinsed with deionized water and air dried. The membrane, which was internally hydrophilic, was not subjected to hydrolyzation or saponification.

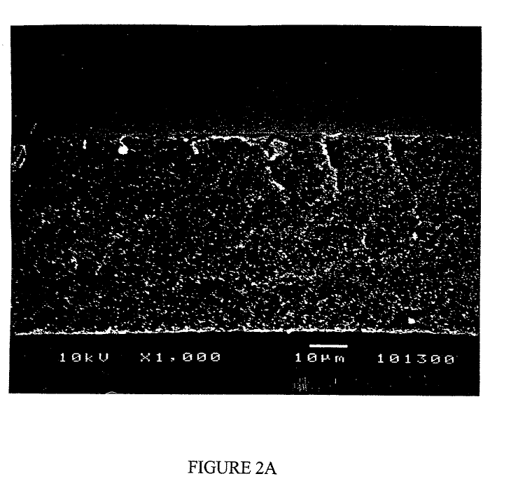

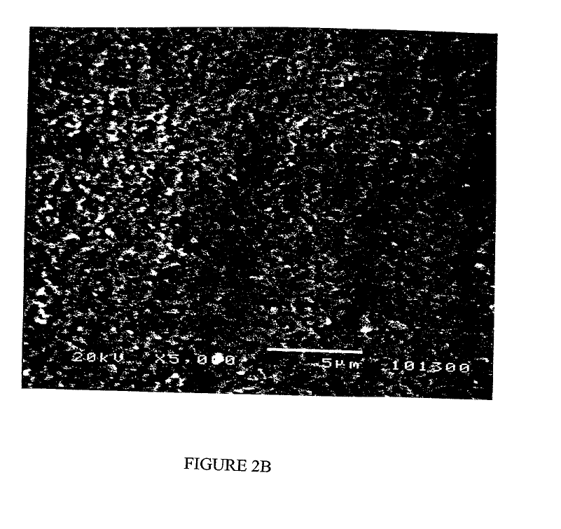

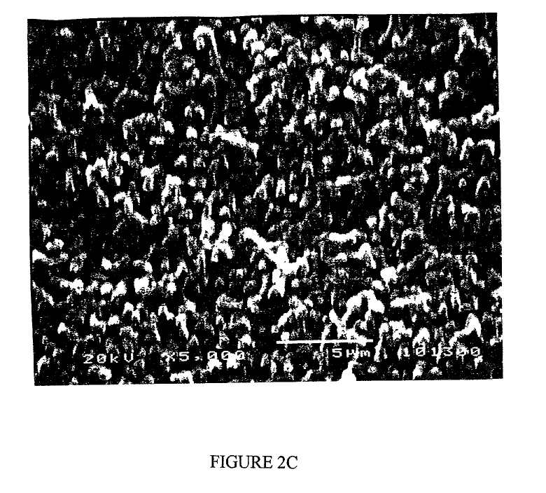

The membrane, having a thickness of approximately 55 μm, exhibited an asymmetry in pore size between the skin surface and the dull surface of approximately 1:3. FIG. 2a provides a scanning electron microscope (SEM) image of a cross section of the membrane. FIG. 2b provides a SEM image of the skin surface of the membrane. FIG. 2c provides a SEM image of the dull surface of the membrane. The membrane was subjected to water flow testing. Maximum pore size, minimum pore size, and MFP size were determined as described above. Test data are provided in Table 1 below.

### Example 3

### 0.1 μm Symmetric Microfiltration Membrane

A solution containing 4.55 wt. % cellulose acetate CA 394-60, 4.55 wt. % CA 398-30, 44.6 wt. % methanol, 46 wt. % N-methyl pyrrolidone (purchased from SOCO-Lynch Corp. of Los Angeles, Calif.), and 0.3 wt. % triethylene glycol (purchased from Aldrich) was prepared. The casting solution, at a temperature of approximately 20° C., was cast onto a moving belt of polyethylene coated paper using a casting knife with a knife gap of approximately 180 μm (7 mils). Following casting, the cast solution was quenched in a bath including 82 vol. % methanol and 18 vol. % water. The cast solution was exposed to air for approximately 2 to 3 seconds before quenching. The air temperature was approximately 20° C. and the relative humidity was approximately 60%. The quench bath had a temperature of approximately 20° C. The resulting membrane was rinsed with deionized water and air dried. The membrane, which was internally hydrophilic, was not subjected to hydrolyzation or saponification.

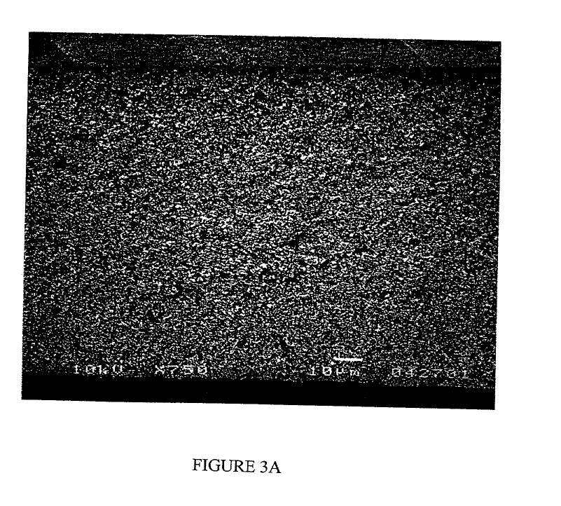

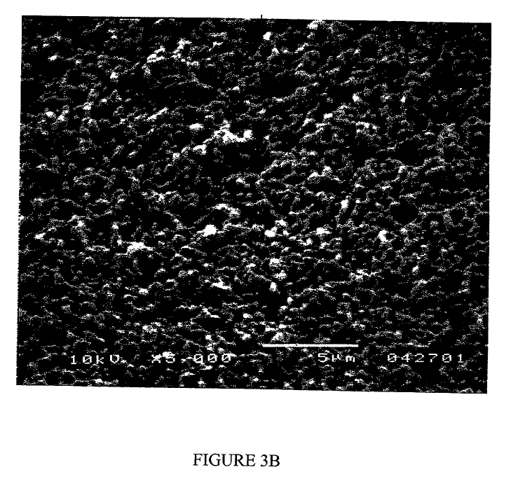

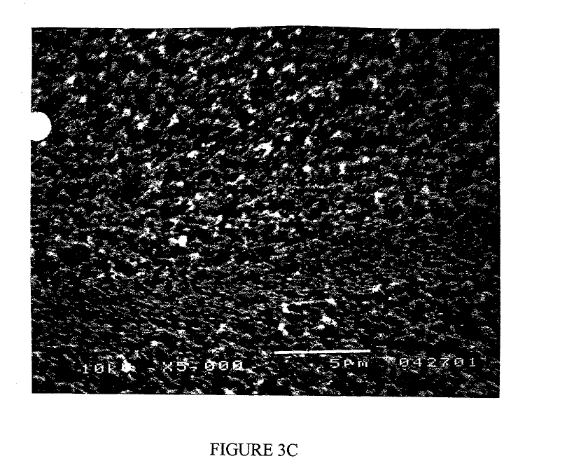

The membrane, having a thickness of approximately 75 μm, exhibited a symmetric structure, with the average pore size for the skin and dull side approximately the same. FIG. 3a provides a scanning electron microscope (SEM) image of a cross section of the membrane. FIG. 3b provides a SEM image of the skin surface of the membrane. FIG. 3c provides a SEM image of the dull surface of the membrane. The membrane was subjected to water flow testing. Maximum pore size, minimum pore size, and MFP size were determined as described above. Test data are provided in Table 1 below.

TABLE 1

| | Water Flow (ml/min) | Maximum | | Minimum |
|---|---|---|---|---|
| | for 90 mm disc at 10 psi | Pore Size | MFP Size | Pore Size |
| Example | (69 kPa) | (μm) | (μm) | (μm) |
| 1 | 3600 | 0.77 | 0.61 | 0.47 |
| 2 | 180 | 0.09 | 0.08 | 0.07 |
| 3 | 280 | 0.12 | 0.1 | 0.07 |

Each of the membranes of Examples 1-3 was internally hydrophilic, as indicated by the water flow test results. To prepare a highly asymmetric membrane according to the preferred embodiments, a casting solution having a low cellulose acetate content and a solvent having a high volatility are preferred. To prepare an isotropic membrane, a casting solution having a high cellulose acetate content and a less volatile solvent are preferred. Generally, the lower the cellulose acetate content in the casting solution or the higher the solvent volatility, the greater the degree of asymmetry observed for the resulting membrane. When a mixture of solvent and non-solvent for the cellulose acetate is used as the quench liquid, microfiltration membranes rather than ultrafiltration membranes are generally formed. Generally, the greater the concentration of solvent in the quench liquid, the larger the pore size on the skin face of the resulting membrane. For smaller pores, it is preferred to use a strong non-solvent as the quench liquid.

### Example 4

### Asymmetric Ultrafiltration Membrane

A solution containing 5 wt. % cellulose acetate CA 394-60S, 5 wt. % CA 398-30, 49 wt. % methanol, 41 wt. % N-methyl pyrrolidone was prepared. The casting solution was cast onto a moving belt of polyester nonwoven support using a casting knife. The nonwoven support is marketed as RO Support by Veratec of Athens, Ga. The temperature of the casting solution was about 45° C. Following casting, the cast solution was quenched in a water bath at a temperature of about 20° C. The cast solution was exposed to air approximately one second before quenching. The air temperature was approximately 20° C. and the relative humidity was approximately 65%. The resulting membrane was rinsed with deionized water and treated with a 12% solution of glycerin in water.

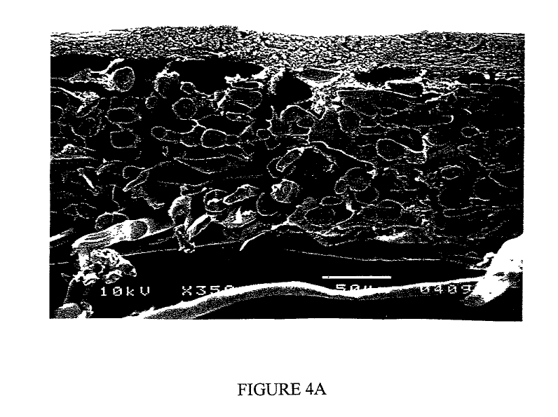

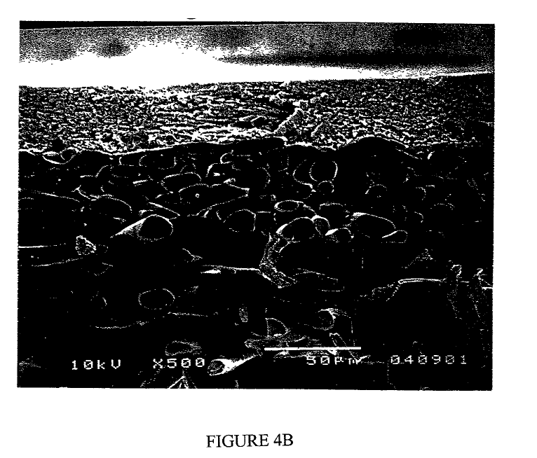

The membrane, having a thickness of approximately 35 μm, exhibited an asymmetric structure. The degree of asymmetry was approximately 1:5. FIG. 4a provides a scanning electron microscope (SEM) image of a cross section of the membrane.

The membrane was subjected to water flow testing and testing for MFP size. The membrane exhibited a MFP size of <0.05μm (below the testing range of the Coulter Porometer). The membrane was also subjected to protein solution permeability and protein retention testing at 20 psig (138 kPa) on a 25 mm diameter disc having an area of approximately 3.8 cm². The test solutions included 0.025 wt. % bovine serum albumin (BSA) in PBS/Azide Buffer Solution (100 K filtered water added to 580.6 g K₂HPO₄ and 226.8 g KH₂PO₄ added to yield one liter of solution, pH adjusted to 7.0-7.2 by addition of K₂HPO₄ or KH₂PO₄) and 0.025 wt. % immunoglobulin G (IgG) in PBS/Azide Buffer Solution. Test results are provided in Table 2.

After testing, the membrane was regenerated by soaking in a solution of approximately 5 to 10 wt. % potassium hydroxide in ethanol for from about one to about ten minutes. After regeneration, the membrane was rinsed in deionized water and treated with a glycerin solution to prevent pore collapse. The membrane was again subjected to water flow testing and protein solution permeability and protein retention testing as described above. Test results are provided in Table 2. FIG. 4b provides a scanning electron microscope (SEM) image of a cross section of the regenerated membrane.

TABLE 2

| | Water Flow (ml/min) for | | |
|---|---|---|---|
| | 90 mm disc at 10 psi | BSA Retention | IgG Retention |
| Regeneration | (69 kPa) | (%) | (%) |
| Before | 1.67 | 89.5 | 99.9 |
| After | 1.68 | 92 | 99.9 |

The membrane, both before and after regeneration, was internally hydrophilic. The regeneration process had no measurable effect on water flow, BSA retention, or IgG retention.

The membranes were instantly wettable and were observed to retain their hydrophilicity over repeated use and regeneration cycles, indicating that the hydrophilicity is permanent and non-leachable.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A cellulosic membrane, the membrane cast from a dope comprising a cellulosic polymer and a solvent, the membrane having a first porous face having a first average pore diameter, a second porous face having a second average pore diameter, and a porous supporting structure therebetween wherein the supporting structure comprises a reticulated network of flow channels, the first and second average pore diameters having an asymmetry of at least about 2:1, and wherein the porous faces and the porous supporting structure comprise a network of structural surfaces capable of contacting a filter stream.

2. The membrane of claim 1, wherein the asymmetry between the average pore diameters of the first porous face and the second porous face is at least about 5:1.

3. The membrane of claim 1, wherein the asymmetry between the average pore diameters of the first porous face and the second porous face is at least about 10:1.

4. The membrane of claim 1, wherein the asymmetry between the average pore diameters of the first porous face and the second porous face is at least about 20:1.

5. The membrane of claim 4, wherein the membrane has a molecular weight cut-off ranging from about 10 k Daltons to about 300 k Daltons.

6. The membrane of claim 4, wherein the membrane has a molecular weight cut-off ranging from about 10 k Daltons to about 50 k Daltons.

7. The membrane of claim 4, wherein the membrane has a molecular weight cut-off ranging from about 10 k Daltons to about 30 k Daltons.

8. The membrane of claim 1, wherein the cellulosic polymer comprises a cellulose ester.

9. The membrane of claim 1, wherein the cellulose ester comprises a cellulose acetate.

10. The membrane of claim 1, wherein the cellulose acetate is selected from the group consisting of cellulose diacetate, cellulose triacetate, cellulose acetate butyrate, cellulose acetate propionate, cellulose nitrate, methyl cellulose, and mixtures thereof.

11. The membrane of claim 1, wherein the cellulosic polymer on a surface of the membrane comprises cellulose.

12. The membrane of claim 1, wherein the cellulose is produced via hydrolyzation of the membrane.

13. The membrane of claim 1, wherein the cellulose is produced via saponification of the membrane.

14. The membrane of claim 1, wherein the dope comprises a dispersion of the cellulosic polymer in the solvent.

15. The membrane of claim 1, wherein the dope comprises a homogeneous solution of the cellulosic polymer in the solvent.

16. A method for preparing a cellulosic membrane, the method comprising:
providing a casting dope comprising a cellulosic polymer, a nonsolvent, and a solvent;
casting the dope to form a thin film;
exposing the film to a humid atmosphere for a period of time sufficient to allow formation of surface pores;
coagulating the film in a coagulation bath; and
recovering from the coagulation bath a cellulosic membrane, the membrane having a first porous face having a first average pore diameter, a second porous face having a second average pore diameter, and a porous supporting structure therebetween, the first and second average pore diameters having an asymmetry of at least about 2:1, wherein the porous faces and the porous supporting structure comprise a network of structural surfaces capable of contacting a filter stream, and wherein the structural surfaces comprise a hydrophilic moiety.

17. The method of claim 16, further comprising:
rinsing the membrane in a rinsing bath, wherein the rinsing step is conducted after the coagulating step.

18. The method of claim 16, further comprising:
drying the membrane at an elevated temperature.

19. The method of claim 16, further comprising:
drying the membrane at room temperature.

20. The method of claim 16, wherein the dope comprises a homogeneous solution.

21. The method of claim 16, wherein the dope comprises a dispersion.

22. The method of claim 16, wherein the nonsolvent is selected from the group consisting of alcohols, alkanes, ketones, carboxylic acids, ethers, esters, and mixtures thereof.

23. The method of claim 16, wherein the nonsolvent is selected from the group consisting of 2-methoxyethanol, propionic acid, t-amyl alcohol, methanol, ethanol, isopropanol, hexanol, heptanol, octanol, acetone, butyl ether, methylethylketone, methylisobutylketone, ethyl acetate, amyl acetate, glycerol, diethyleneglycol, di(ethyleneglycol)diethylether, di(ethyleneglycol)dibutylether, polyethylene glycol, propionic acid, hexane, propane, nitropropane, heptane, octane, and mixtures thereof.

24. The method of claim 16, wherein the nonsolvent comprises water.

25. The method of claim 16, wherein the nonsolvent comprises an alcohol.

26. The method of claim 16, wherein the alcohol is selected from the group consisting of methanol, ethanol, and mixtures thereof.

27. The method of claim 16, wherein the nonsolvent comprises a mixture of water and an alcohol selected from the group consisting of methanol, ethanol, and mixtures thereof.

28. The method of claim 16, wherein the solvent is selected from the group consisting of dimethylformamide, dimethylacetamide, dioxane, dimethylsulfoxide, chloroform, tetramethylurea, tetrachloroethane, and mixtures thereof.

29. The method of claim 16, wherein the solvent comprises N-methylpyrrolidone.

30. The method of claim 16, wherein the solvent comprises methylene chloride.

31. The method of claim 16, wherein the dope further comprises triethylene glycol.

32. The method of claim 16, wherein the dope comprises from about 2 wt. % to about 60 wt. % of nonsolvent.

33. The method of claim 16, wherein the dope comprises from about 40 wt. % to about 75 wt. % of solvent.

34. The method of claim 16, wherein the dope comprises from about 3 wt. % to about 20 wt. % of cellulosic polymer.

35. The method of claim 16, wherein the dope comprises up to about 5 wt. % of triethylene glycol.

36. The method of claim 16, wherein the dope further comprises a hydrophilic component.

37. The method of claim 16, wherein the coagulation bath comprises water.

38. The method of claim 37, wherein the coagulation bath further comprises methanol.

39. The method of claim 17, wherein the rinse bath comprises water.

40. A method for separating a protein from a liquid, the method comprising:
providing a liquid containing a protein;
providing a cellulosic membrane, the membrane cast from a dope comprising a cellulosic polymer and a solvent, wherein the membrane has a first porous face having a first average pore diameter, a second porous face having a second average pore diameter, and a porous supporting structure therebetween wherein the supporting structure comprises a reticulated network of flow channels, the first and second average pore diameters having an asymmetry of at least about 2:1, wherein the porous faces and the porous supporting structure comprise a network of structural surfaces capable of contacting a filter stream, wherein the membrane comprises a cellulosic polymer, wherein the structural surfaces comprise a hydrophilic moiety, and wherein the membrane has a molecular weight cut-off ranging from about 10 k Daltons to about 300 k Daltons; and
contacting the liquid with the membrane, whereby a filtrate passes through the membrane and whereby a substantial quantity of the protein is retained by the membrane.

41. The method of claim 40, wherein the liquid comprises a dairy product or bioprocessing stream.

42. The method of claim 41, wherein the dairy product comprises milk.
